(19) United States
(12) Patent Application Publication
(10) Pub. No.: US 2009/0290289 A1
(43) Pub. Date: Nov. 26, 2009

(54) SOLID ELECTROLYTIC CAPACITOR AND MANUFACTURING METHOD THEREOF

(75) Inventor: Sung Wook HAN, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon-si (KR)

(21) Appl. No.: 12/273,085

(22) Filed: Nov. 18, 2008

(30) Foreign Application Priority Data
May 21, 2008 (KR) 10-2008-0046866

(51) Int. Cl. H01G 9/15; H01G 9/00

(52) U.S. Cl. 361/523; 29/25.03

(57) ABSTRACT

The present invention relates to a solid electrolytic capacitor and a manufacturing method thereof capable of reducing the ESR(Equivalent Series Resistance) and the ESL(Equivalent Series Inductance).

In accordance with the present invention, a solid electrolytic capacitor including a plurality of metal powder elements connected in parallel and having anode wires formed in the opposite directions; anode terminals provided on both ends of the metal powder elements respectively and connected to the anode wires; a cathode terminal provided on lower portions of the metal powder elements and connected to the metal powder elements; and an external resin for sealing the metal powder elements connected to the anode terminals and the cathode terminal.

### CROSS-REFERENCE TO RELATED APPLICATIONS

This application claims the benefit of Korean Patent Application No. 10-2008-0046866 filed with the Korea Intellectual Property Office on May 21, 2008, the disclosure of which is incorporated herein by reference.

### BACKGROUND OF THE INVENTION

1. Field of the Invention

The present invention relates to a solid electrolytic capacitor and a manufacturing method thereof; and, more particularly, to a solid electrolytic capacitor capable of reducing ESR(Equivalent Series Resistance) and ESL(Equivalent Series Inductance) by stacking a plurality of metal powder elements or horizontally connecting the metal powder elements in parallel and a manufacturing method thereof.

2. Description of the Related Art

Generally, a solid electrolytic condenser referred to as a tantalum condenser has been chiefly used for an application circuit with a low rated voltage use range as well as general industrial instruments, particularly for a circuit with a poor frequency characteristic. In general, the solid electrolytic condenser has been mainly used for reducing noise of mobile communication equipment.

A conventional tantalum condenser 10, as shown in FIG. 1, includes a condenser element 12 embedded inside a case 11, an anode wire 18 integrally formed on the condenser element and projected from the condenser element 12, an anode terminal 13 welded to the anode wire 18 and drawn outside the case, and a cathode terminal 14 in contact with the condenser element 12.

As the tantalum condenser 10 has recently been used to a small device frequently, it is gradually trending toward miniaturization in comparison with a conventional condenser. When the condenser is miniaturized, because a contact portion between the condenser element 12 and the anode and cathode terminals 13 and 14 takes up much space, the tantalum condenser 12 relatively decreases in size. This causes a problem that volume efficiency occupied by the condenser element 12 of the tantalum condenser 10 is reduced and therefore impedance, ESR and ESL are increased.

Further, because reduction of the size of each of the anode and cathode terminals 13 and 14 is very limited in order to firmly fix the anode and cathode terminals 13 and 14 inserted inside, the sizes of the anode and cathode terminals 13 and 14 inserted inside the case 11 are limited.

That is, because the anode and cathode terminals 13 and 14 fixed through molding must be firmly fixed, excessive reduction of the sizes thereof interferes with firm fixation.

And, the conventional tantalum condenser 10 is formed such that the anode terminal 13 and the cathode terminal 14 face each other on both ends of the tantalum condenser 10 and so an anode and a cathode are inversely connected, whereby an inverse voltage is applied.

### SUMMARY OF THE INVENTION

The present invention has been invented in order to overcome the above-described problems and it is, therefore, an object of the present invention to provide a solid electrolytic capacitor and a manufacturing method thereof capable of reducing ESR(Equivalent Series Resistance) and ESL(Equivalent Series Inductance) by stacking or a plurality of metal powder elements or horizontally connecting the metal powder elements in parallel.

The object of the present invention can be achieved by providing a solid electrolytic capacitor including a plurality of metal powder elements connected in parallel and having anode wires formed in the opposite directions; anode terminals provided on both ends of the metal powder elements respectively and connected to the anode wires; a cathode terminal provided on lower portions of the metal powder elements and connected to the metal powder elements; and an external resin for sealing the metal powder elements connected to the anode terminals and the cathode terminal.

At this time, the metal powder elements may be made of tantalum or niobium.

Further, an adhesive may be further included between the metal powder elements and the adhesive may be made of conductive material such as Au or Ag.

The metal powder elements may be stacked and connected in parallel or be horizontally connected in parallel.

Further, the object of the present invention can be achieved by providing a manufacturing method of a solid electrolytic capacitor including the steps of: preparing a plurality of metal powder elements provided with anode wires projected on one side ends; connecting the metal powder elements in parallel to position the anode wires of the adjacent metal powder elements in the opposite directions; coupling anode terminals at lower portions of each of the anode wires of the parallel connected metal powder elements; coupling a cathode terminal on lower portions of the metal powder elements coupled with the anode terminals; and forming an external resin to seal the metal powder elements.

At this time, the metal powder elements may be made of tantalum or niobium.

Further, the metal powder elements may be coupled by using an adhesive and the adhesive may be made of conductive material such as Au or Ag.

Further, in the step of connecting the metal powder elements in parallel, the metal powder elements may be stacked and connected in parallel or be horizontally connected in parallel.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view showing a capacitor according to a prior art;

FIG. 2 is a perspective view showing a solid electrolytic capacitor in accordance with the present invention;

FIG. 3 is perspective view showing a coupling state of a plurality of metal powder elements in accordance with the present invention;

FIG. 4 is a plane-view showing a plurality of metal powder elements in accordance with the present invention;

FIG. 5 is a perspective view showing a modified embodiment of the present invention; and

FIG. 6 to FIG. 8 are perspective views showing a manufacturing method of a solid electrolytic capacitor in accordance with the present invention.

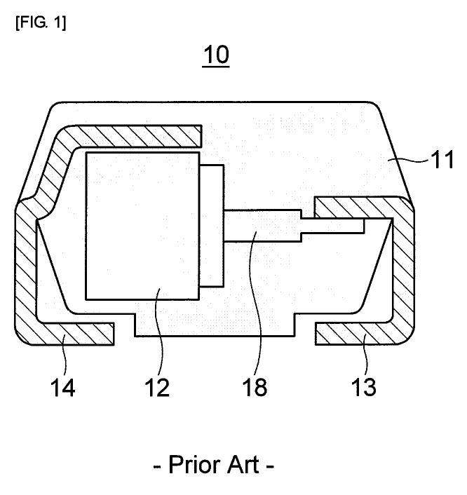

### DETAILED DESCRIPTION OF THE PREFERRED EMBODIMENTS

A subject regarding to a structure, a manufacturing method and an effect of a solid electrolytic capacitor in accordance with the present invention will be clearly appreciated through the following detailed description with reference to the accompanying drawings illustrating preferable embodiments of the present invention.

### Embodiment

Hereinafter, a solid electrolytic capacitor and a manufacturing method thereof in accordance with one embodiment of the present invention will be described in detail with reference to the accompanying related drawings.

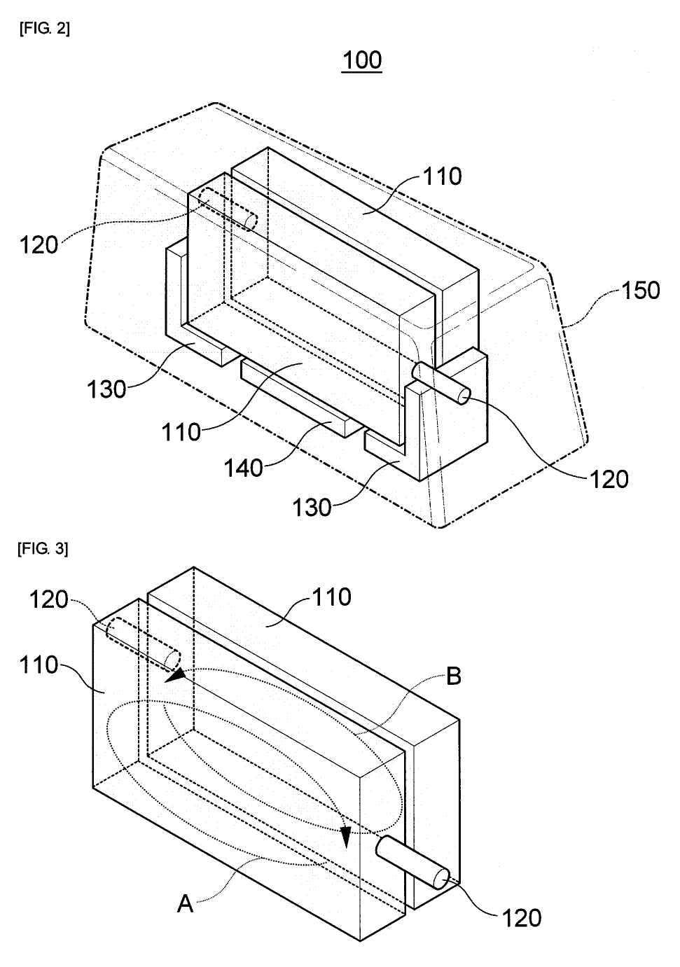

FIG. 2 is a perspective view showing a solid electrolytic capacitor in accordance with the present invention, FIG. 3 is perspective view showing a coupling state of a plurality of metal powder elements in accordance with the present invention, and FIG. 4 is a plane-view showing a plurality of metal powder elements in accordance with the present invention.

First of all, as shown in FIG. 2, in accordance with the one embodiment of the present invention, the solid electrolytic capacitor 100 includes a plurality of metal powder elements 110 connected in parallel, anode wires 120 projected on one ends of the metal powder elements 110, anode terminals 130 connected to the anode wires 120, a cathode terminal 140 connected to lower parts of the metal powder elements 110 and an external resin 150 for sealing the metal powder elements 110. At this time, the solid electrolytic capacitor 100 of the present invention preferably uses conductive polymers as a solid electrolyte.

Herein, the metal powder elements 110 are made of metal powder such as tantalum or niobium and formed in a hexahedral shape to be connected to the adjacent metal powder elements 110 in parallel.

At this time, on one surface of each of the metal powder elements 110, there is provided one anode wire 120 projected to the outside. Further, the metal power elements 110 may be horizontally coupled with each other to be connected in parallel.

Particularly, the metal powder elements 110 are preferably positioned so that the anode wires 120 of the adjacent metal powder elements 110 are positioned in the opposite directions.

The reason is, as shown in FIG. 3 that magnetic fields flow in the opposite directions and the magnetic fields are reduced in size by positioning the anode wires 120 of the adjacent metal powder elements 110 in the opposite directions, whereby total resistance is reduced.

For example, the magnetic field of the metal powder element 110 of which the anode wire 120 is positioned on the right thereof flows in a clockwise direction as a shown “A” and the magnetic field of the metal powder element 110 of which the anode wire 120 is positioned on the left thereof flows in a counterclockwise direction as a shown “B”.

Therefore, the magnetic fields of the adjacent metal powder elements 110 flow in the opposite directions, whereby the magnetic fields can be offset from each other.

Accordingly, the solid electrolytic capacitor 100 in accordance with the present invention has an advantage that the ESR and the ESL can be reduced as the sizes of the magnetic fields and the entire resistance are reduced by positioning and coupling the adjacent metal power elements 110 such that the anode wires 120 thereof are positioned in the opposite directions.

The anode wires 120 are projected from insides of the metal powder elements 110 and the anode terminals 130 are provided on the lower portions of the anode wires 120 to supply power from the outside of the external resin 150 to the anode wires 120.

At this time, the anode wires 120 are made of conductive material and may be formed in a circular bar or polygonal bar shape.

Further, the metal powder elements 110, as shown in FIG. 4, are adhered through an adhesive 160. The adhesive 160 is preferably made of conductive material such as Au or Ag to conduct electricity between the connected metal powder elements 110.

The anode terminals 130 are positioned and coupled on the lower portions of the anode wires 120 to supply the power from the outside to the metal powder elements 110 and supplies the power to each of the metal powder elements 110 through the anode wires 120.

And, the cathode terminal 140 is formed on the lower parts of the metal powder elements 110 and may be formed on the lower parts of the metal powder elements 110 or upper parts thereof.

Therefore, in the solid electrolytic capacitor 100 in accordance with the present invention, the anode terminals 130 and the cathode terminal 140 can be definitely divided without confusion of positions thereof by positioning the anode terminals 130 on both side ends of the solid electrolytic capacitor 100 and positioning the cathode terminal 140 on a lower part or an upper part thereof.

Therefore, it is possible to improve reliability of the solid electrolytic capacitor 100 by preventing an inverse voltage due to confusion of the terminals caused by providing an anode terminal and a cathode terminal on each side ends of a solid electrolytic capacitor one by one as conventionally arranged.

Further, because the metal powder elements 110 are coupled through the conductive adhesive 160, the plural metal powder elements 110 can be connected through the one cathode terminal 140 without connecting the cathode terminal 140 per metal powder element independently, thereby downsizing the solid electrolytic capacitor 100.

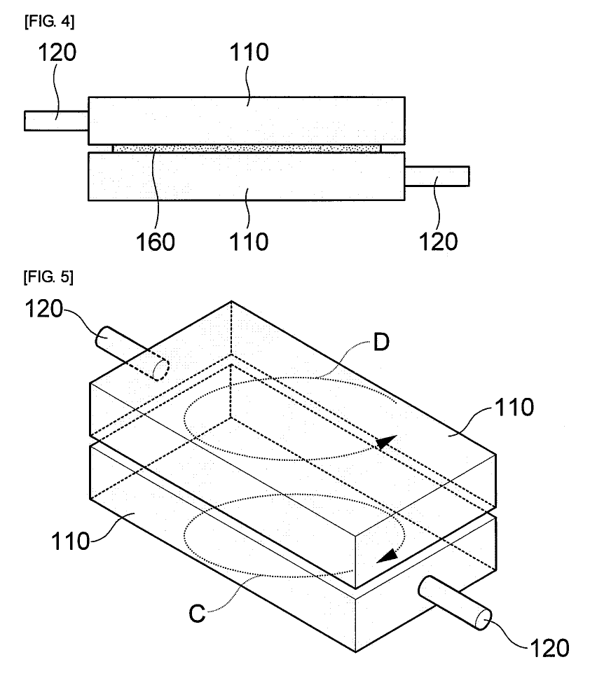

Meanwhile, as shown in FIG. 5 as a perspective view showing a modified embodiment of the solid electrolytic capacitor in accordance with the one embodiment of the present invention, the metal powder elements 110 provided inside the solid electrolytic capacitor 100 are not horizontally connected in parallel but may be sequentially stacked and connected in parallel.

Even when the plural metal powder elements 110 are stacked, it is preferable to reduce the sizes of the magnetic fields and the ESR by forming the magnetic fields in the opposite directions as shown “C” and “D” and offsetting the sizes thereof by positioning the anode wires 120 in the opposite directions.

At this time, the metal powder elements 110, as shown in FIG. 4, are coupled with each other by using the adhesive 160 made of the conductive material.

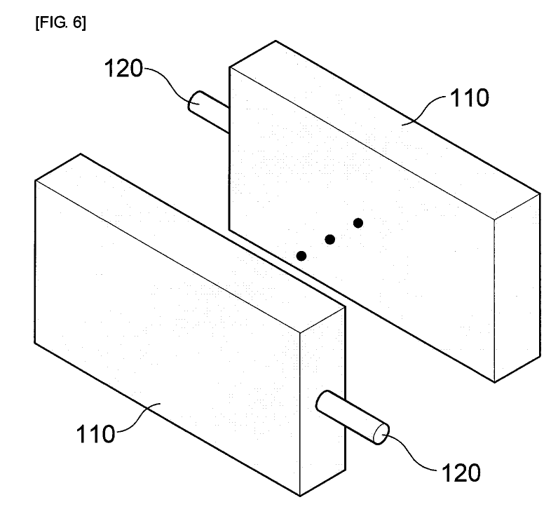

Hereinafter, a manufacturing method of a solid electrolytic capacitor 100 in accordance with the one embodiment of the present invention will be described with reference to FIG. 6 to FIG. 8 and the above-mentioned FIG. 2.

FIG. 6 to FIG. 8 are perspective views showing a manufacturing method of a solid electrolytic capacitor in accordance with the present invention.

First of all, as shown in FIG. 6, a plurality of metal elements 110 each of which has an anode wire 120 on any one end thereof are prepared.

At this time, the metal powder elements 110 are made of metal powder such as tantalum or niobium and preferably formed in a hexahedral shape to be connected to the adjacent metal powder elements 110 in parallel.

Then, as shown in FIG. 7, after applying an adhesive 160 on lateral faces of the prepared metal powder elements 110, the metal powder elements are closely coupled to be horizontally connected in parallel.

At this time, the adhesive 160 is preferably made of conductive material such as Au or Ag to conduct electricity between the connected metal powder elements 110.

Particularly, it is preferable to position the anode wires 120 of the adjacent metal powder elements 110 in the opposite directions so as to offset sizes of magnetic fields by allowing the magnetic fields of the metal powder elements 110 to flow in the opposite directions.

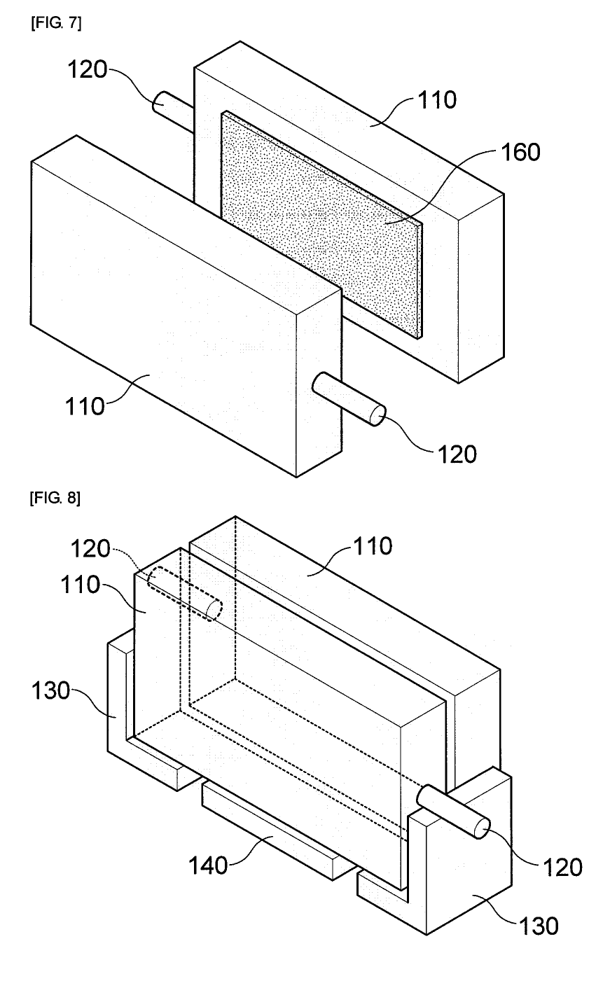

After coupling the metal powder elements 110, as shown in FIG. 8, anode terminals 130 for supplying power from the outside are positioned on lower portions of the anode wires 120 each of which is projected to one side of each of the metal powder elements 110 and a cathode terminal 140 is positioned on lower parts of the metal powder elements 110.

At this time, the anode terminals 130 and the cathode terminal 140 are preferably made of conductive material through which electricity can be conducted.

Further, in the FIG. 8, the cathode terminal 140 is formed on the lower parts of the metal powder elements 110, however, the cathode terminal 140 may be formed on upper end portions of the metal powder elements 110.

As described above, after coupling the anode terminals 130 and the cathode terminal 140 with the metal powder terminals 110, the solid electrolytic capacitor 100 in accordance with the one embodiment of the present invention as shown in FIG. 2 can be manufactured by sealing the metal powder elements 110 with molding material and so forming an external resin 150.

Meanwhile, although the metal powder elements 110 have been explained for a case that they are horizontally connected in parallel, but they can be connected in parallel to be vertically stacked without limiting to this.

As described above, in accordance with the preferable embodiments of the present invention, the solid electrolytic capacitor and the manufacturing method thereof are capable of reducing the ESR and the ESL by stacking the metal powder elements or horizontally connecting the metal powder elements in parallel.

Further, the solid electrolytic capacitor and the manufacturing method thereof are capable of preventing an inverse voltage by providing the anode terminals as the same terminals on the both side ends of the solid electrolytic capacitor and providing the cathode terminal on the lower portion thereof.

And, in accordance with the present invention, it is possible to miniaturize the solid electrolytic capacitor by providing the cathode terminal on only any one surface of the lower portions or the upper portions of the metal powder elements.

As described above, although a few preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

What is claimed is:

1. A solid electrolytic capacitor comprising:
a plurality of metal powder elements connected in parallel and including anode wires formed in the opposite directions;
anode terminals provided on both ends of the metal powder elements respectively and connected to the anode wires;
a cathode terminal provided on lower portions of the metal powder elements and connected to the metal powder elements; and
an external resin for sealing the metal powder elements connected to the anode terminals and the cathode terminal.

2. The solid electrolytic capacitor according to claim 1, wherein the metal powder elements are made of tantalum or niobium.

3. The solid electrolytic capacitor according to claim 1, further comprising an adhesive formed between the metal powder elements.

4. The solid electrolytic capacitor according to claim 3, wherein the adhesive is made of conductive material such as Au or Ag.

5. The solid electrolytic capacitor according to claim 1, wherein the metal powder elements are stacked and connected in parallel.

6. The solid electrolytic capacitor according to claim 1, wherein the metal powder elements are horizontally connected in parallel.

7. A manufacturing method of a solid electrolytic capacitor comprising the steps of:
preparing a plurality of metal powder elements provided with anode wires projected on one side ends;
connecting the metal powder elements in parallel to position the anode wires of the adjacent metal powder elements in the opposite directions;
coupling anode terminals at lower portions of each of the anode wires of the parallel connected metal powder elements;
coupling a cathode terminal on lower portions of the metal powder elements coupled with the anode terminals; and
forming an external resin to seal the metal powder elements.

8. The method according to claim 7, wherein the metal powder elements are made of tantalum or niobium.

9. The method according to claim 7, wherein the powder elements are coupled by using an adhesive.

10. The method according to claim 9, wherein the adhesive is made of conductive material such as Au or Ag.

11. The method according to claim 7, wherein in the step of connecting the metal powder elements in parallel, the metal powder elements are stacked and connected in parallel.

12. The method according to claim 7, wherein in the step of connecting the metal powder elements in parallel, the metal powder elements are horizontally connected in parallel.
